(19) United States
(12) Patent Application Publication
(10) Pub. No.: US 2006/0042565 A1
(43) Pub. Date: Mar. 2, 2006

(54) Integrated fuel injection system for on-board fuel reformer

(75) Inventor: Haoran Hu, Novi, MI (US)

Correspondence Address: PAUL V. KELLER, LLC, 4585 LIBERTY RD., SOUTH EUCLID, OH, 44121, US

(73) Assignee: Eaton Corporation, Cleveland, OH (US)

(21) Appl. No.: 10/927,353

(22) Filed: Aug. 26, 2004

(51) Int. Cl. F02B 43/08

(52) U.S. Cl. 123/3; 123/557

(57) ABSTRACT

The invention relates to a fuel reforming system in which an intensifier is used to pressurize the fuel. An intensifier is a simple device that can be used to step up the pressure provided by a conventional fuel pump. The fuel at increased pressure is passed through a nozzle. As the fuel leaves the nozzle, it atomizes and partially vaporizes. Optionally, the nozzle entrains air through the Venturi effect. Treating the fuel in this manner promotes mixing, increase reformer efficiency, and reduces the formation of byproducts. The invention is particularly suited to vehicle-mounted fuel reformer systems.

### FIELD OF THE INVENTION

The present invention relates to fuel reformers in general and a vehicle-mounted diesel fuel reformer in particular.

### BACKGROUND OF THE INVENTION

Fuel reformers can be used to break long chain hydrocarbons into smaller more reactive molecules such as short chain hydrocarbons, oxygenated hydrocarbons, hydrogen, and carbon monoxide. For vehicles, fuel reformers have been proposed for use in connection with fuel cells, to produce low emission combustion fuels, and also as a source of reducing species for regenerating of NOx traps in emission abatement systems.

U.S. Pat. No. 4,108,114 discloses a compression ignition engine having one cylinder adapted to operate as an on-board fuel reformer. Fuel and air are mixed prior to injection into the cylinder and at least one of these components is pre-heated by either exhaust gas or the reformer product. The reformer product can be supplied to the power cylinders of the engine to reduce emissions.

U.S. Pat App. No. 2004/0124259 describes a system for producing a fine mist of sub-micron sized fuel particles and suggests using the system in an on-board fuel reformer. The pressurized fuel is heated prior to discharging the fluid into a discharge zone. Prior to discharge, the fuel is heated to a temperature at which the fuel's vapor pressure exceeds the pressure in the discharge zone. The fuel is preferably heated using a glow plug.

There remains a long felt need for more efficient fuel reformers that can be used on-board vehicles.

### SUMMARY OF THE INVENTION

The following presents a simplified summary in order to provide a basic understanding of some aspects of the invention. This summary is not an extensive overview of the invention. The primary purpose of this summary is to present some concepts of the invention in a simplified form as a prelude to the more detailed description that is presented later.

One aspect of the invention relates to a fuel reforming system in which an intensifier is used to pressurize the fuel. An intensifier is a simple device that can be used to step up the pressure provided by a conventional fuel pump. The fuel at increased pressure is passed through a nozzle. As the fuel leaves the nozzle, it atomizes and partially vaporizes. Optionally, the nozzle entrains air through the Venturi effect. Treating the fuel in this manner promotes mixing, increase reformer efficiency, and reduces the formation of byproducts. The invention is particularly suited to vehicle-mounted fuel reformer systems.

To the accomplishment of the foregoing and related ends, the following description and annexed drawings set forth in detail certain illustrative aspects and implementations of the invention. These are indicative of but a few of the various ways in which the principles of the invention may be employed. Other aspects, advantages and novel features of the invention will become apparent from the following detailed description of the invention when considered in conjunction with the drawings.

### BRIEF DESCRIPTION OF THE DRAWINGS

FIG. 1 is a schematic illustration of an exemplary fuel reforming system;

FIG. 2 is an illustration of a nozzle;

FIG. 3 is an illustration of another nozzle.

### DETAILED DESCRIPTION OF THE INVENTION

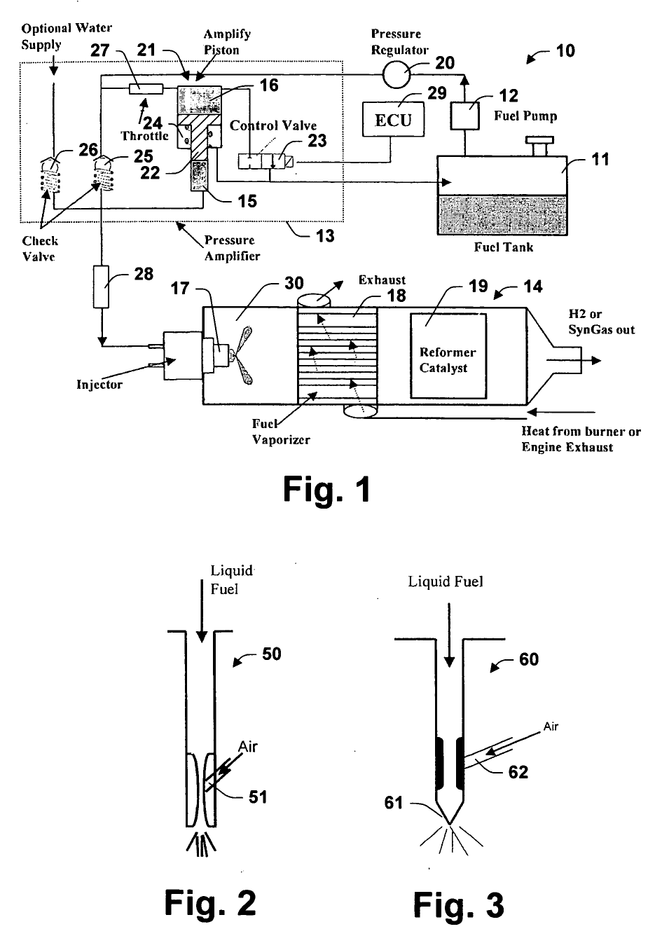

FIG. 1 is a schematic illustration of an exemplary fuel reforming system 10 according to one aspect of the present invention. The fuel reforming system 10 comprises a fuel tank 11, a fuel pump 12, a pressure intensifier 13 comprising a piston intensifier 21, and a reformer 14. The fuel pump 12 is supplies fuel from the fuel tank 11 at a first pressure. The fuel, optionally combined with water, is drawn into a lower chamber 15 of the piston intensifier 21. Fuel is then supplied to an upper chamber 16 of the piston intensifier 21, whereby the fuel acts on the upper surface of a piston 22 to pressurize the fuel in the lower chamber 15. The intensifier 13 increases the fuel's pressure over the pressure provided by the fuel pump 12, typically by a factor of about 3 to about 10. The pressurized fuel enters the fuel reformer 14 through a nozzle 17. The fuel and water atomize, mix with air, and partially vaporize as they are expelled from the nozzle 17. Air can be drawn into the reformer through the nozzle 17 by the Venturi effect. The fuel is further vaporized in a heat exchanger 18 before passing over a reformer catalyst 19.

Any suitable fuel can be used, but the invention is particularly adapted to fuels such as gasoline and diesel and for use in vehicle mounted systems. Vehicle mounted systems have constraints as to size and must be able to endure the vibrations inherent in vehicle-mounted systems. The fuel tank 11 is therefore typically a vehicle fuel tank. The fuel pump 12 is generally a commercially available electric fuel pump, typically giving a pressure from about 3 to about 6 bar. The fuel may be supplied from the fuel pump 12 to the intensifier 13 through a pressure regulator 20.

A pressure intensifier is a device that takes a working fluid at a first pressure and uses it to pump fluid at a second, higher pressure. The pumped fluid and the working fluid can be one and the same. The elevated pressure is achieved by directing a force generated by the working fluid acting on a first area against the pumped fluid through a second, smaller area.

A typical pressure intensifier comprises a piston intensifier, such as piston intensifier 21. The working fluid is supplied to an upper chamber 16 and the pumped fluid is supplied to the lower chamber 15. The working fluid operates on the large upper cross-sectional area of the piston 22 and compresses the pumped fluid through the smaller lower cross-sectional area of the piston 22. During filling of the piston with pumped fluid, the pressure in the upper chamber 16 is relieved. In the example, the upper chamber 16 contains fuel that is allowed to drain through control valve 23 to the fuel tank 11. The middle chamber 24 of the piston 21 can also be vented to the fuel tank 11. The lower chamber 15 is charged through check valve 25. Where water is provided, it can be drawn in or pumped in through check valve 26.

During the compression stroke of the intensifier 21 the throttle valve 27 is open and the control valve 23 is shut. The pressurize fuel is driven to the nozzle 17 through check valve 28. A control unit, which may be engine control unit 29, may control all the valves 23, 27, and 28. The flow rate of high-pressure fuel may be controlled by varying the stroke length of the piston 21 or by varying the stroke frequency. Optionally, the high-pressure fuel can be stored in a reservoir, whereby a steady flow can be provided to the nozzle 17. Optionally, the fuel is heated before passing through the nozzle 17. Any suitable heating system can be used, including for example a heat exchanger or an electrical resistance heater, such a glow plug. Heating can promote atomization and partial vaporization of the fuel as it passes through the nozzle 17.

FIG. 2 illustrates an exemplary nozzle 50 and FIG. 3 illustrates another exemplary nozzle 60. The nozzle 60 incorporates nozzle holes 61 to control drop size, whereas the nozzle 50 atomizes the fuel solely through the effect of a sudden pressure decrease. Both nozzles can draw in air through the Venturi principle. The nozzle 60 is provided with a passage 62 for this purpose whereas the nozzle 50 is provided with a passage 51. Optionally, pressurized air can be provided to the passages 62 and 51. Optionally, air can be supplied to the reformer 14 separate from the nozzle 17.

The nozzle 17 can draw in gases to be mixed with the fuel other than, or in addition to, air. Other gases that might be mixed with the fuel include for supply to the fuel reformer include, without limitation, relatively pure oxygen, exhaust, water vapor, and recirculated exhaust from either the reformer or from a fuel cell.

The reformer 14 can have a mixing chamber 30. A mixing chamber is a zone, optionally containing baffles, swirlers, or other devices designed to promote mixing of fuel and air. After passing through the nozzle 17, the fuel is atomized and generally partially vaporized.

The reformer 14 is provided with an optional heat exchanger 18. The heat exchanger 18 acts to further vaporize and mix the fuel, as well providing a high temperature for a fuel reforming reaction. The heat exchanger 18 can draw heat from any appropriate source, including for example from engine exhaust, exhaust from the reformer, exhaust from a fuel cell, or a burner. The heat source can pass directly through the reformer or the energy can be first transferred to a heat exchange medium that is passed through the heat exchanger 18.

The reformer 14 can be any type of reformer. Reformers can be characterized in terms of the amount and types of oxidant sources supplied and the steps taken to promote reaction. The oxidant source is generally either oxygen or water. Oxygen can be supplied from air, from lean exhaust, or in a relatively pure form, as in oxygen produced from hydrogen peroxide or water. Partial oxidation by oxygen is exothermic and partial oxidation by water in endothermic. A balance between the two can be selected to achieve a desired degree of heat release, heat consumption, or an energy neutral reaction in the reformer 14. The reformer 14 can promote reaction with one or more of heat, a catalyst, and plasma. Plasma is typically generated with an electric arc. Specific reformer types include steam reformers, autothermal reformers, partial oxidation reformers, and plasma reformers. The invention is applicable to any of these reformers types and provides functions such as reducing byproducts, which may include soot or carbon, and increasing efficiency.

A reformer catalyst can be any suitable catalyst. Preferably, the reformer catalyst is one that favors the production of CO and H₂ (syn gas) and small hydrocarbons over complete oxidation of diesel fuel to form CO₂ and H₂O. In particular, the production of relatively large amounts of H₂ is a preferred characteristic of a reformer catalyst. Examples of reformer catalysts include oxides of Al, Mg, and Ni, which are typically combined with one or more of CaO, K₂O, and a rare earth metal such as Ce to increase activity.

The reformer catalyst 19 is preferably adapted for use in vehicle exhaust systems. Vehicle exhaust systems create restriction on weight, dimensions, and durability. The reformer catalyst 19 is optionally provided with mechanisms for heating and/or cooling. For example, the catalyst 19 can be permeated with heat-exchange passages. The catalyst 19 can have any suitable structure. Examples of suitable structures may include monoliths, packed beds, and layer screening. A packed bed is preferably formed into a cohesive mass by sintering the particles or adhering them with a binder.

In one embodiment, the reformer 14 is provided in a vehicle exhaust system. In this embodiment, the high-pressure fuel is injected into an exhaust pipe and reformation takes place with oxygen present in the exhaust. In this case, the heat exchanger 18 would generally not be used. An exhaust pipe is a conduit configured to receive, or adapted to receive, the bulk of the exhaust flow from an engine.

In another embodiment, the pressure intensifier 13 and the reformer 14 are provided in a single housing. Preferably, the package is designed for mounting on a vehicle, where the package can be coupled to a fuel line and used to produce syn gas. Optionally, the package is part of an auxiliary power system.

Another embodiment of the invention relates to a power system comprising a fuel reformer system according to the present invention and a fuel cell. The fuel cell can be of any type, but is usually a solid oxide electrolyte fuel cell. The fuel cell uses the reformer product as feed and may be contained with the reformer in a single housing. The fuel cell generally comprises a plurality of cells connected in series. Typically, oxygen is reduced at one electrode to form oxygen ions, which diffuse through the electrolyte and react with reformed fuel on the other side.

The oxygen electrode of the fuel cell can be a doped ceramic of the perovskite family, for example, doped LaMnO₃. The electrolyte can be, for example, yttria-stabilized zirconia. The fuel electrode can be, for example, a zirconia-nickel cermet material. A typical operating temperature for the fuel cell would be in the range from about 600 to about 1000° C. The fuel cell can operate at approximately the same temperature as the reformer.

Optionally, a portion of the reformer product can be recirculated to increase conversion. Recirculation can involve compressing the reformer product and injecting it anywhere upstream of the catalyst 19. Preferably, the reformer product is recirculated to the mixing chamber 30. More preferably, the reformer product is drawn by the Venturi effect through the nozzle 17.

The invention has been shown and described with respect to certain aspects, examples, and embodiments. While a particular feature of the invention may have been disclosed with respect to only one of several aspects, examples, or embodiments, the feature may be combined with one or more other features of the other aspects, examples, or embodiments as may be advantageous for any given or particular application.

The claims are:

1. A fuel reforming system, comprising:
a pressure intensifier; and
a fuel reformer; wherein
the pressure intensifier is adapted to receive fuel from a fuel pump and supply it with an increased pressure to the fuel reformer.

2. The fuel reforming system of claim 1, wherein;
the pressure intensifier comprises a piston having a first end having a first area and a second end having a second, smaller area;
the pressure intensifier is configured for fuel from the fuel pump to act on the first end to pressurize fuel from the fuel pump at the second end; and
the pressure intensifier is configured to supply the pressurized fuel from the second end to the reformer.

3. The fuel reforming system of claim 1, further comprising a nozzle configure for the fuel from the pressure intensifier to pass through on its way to the fuel reformer.

4. The fuel reforming system of claim 3, further comprising a heat exchanger configured to heat the fuel after it passes through the nozzle.

5. The fuel reforming system of claim 4, wherein the heat exchanger is adapted to couple with a vehicle exhaust system to heat the fuel with exhaust.

6. The fuel reforming system of claim 3, where the nozzle vents into a chamber and the nozzle is configure to draw a gas such as air into the chamber through the Venturi effect.

7. The fuel reforming system of claim 1, wherein the system further comprises the fuel pump and the fuel pump is an electric fuel pump.

8. The fuel reforming system of claim 7, wherein the electric fuel pump supplies fuel at a pressure from about 2 to about 6 bar and the pressure intensifier at least about doubles the pressure.

9. The fuel reforming system of claim 1, wherein the pressure intensifier is configured to draw water from a water supply and supply the fuel to the fuel reformer together with the water.

10. The fuel reforming system of claim 3, where the nozzle vents into a chamber and the system is configured to receive pressurized air for mixing with the fuel within the chamber.

11. The fuel reforming system of claim 10, wherein the nozzle is configured to draw pressurized air into the chamber through the Venturi effect.

12. A power generation system, comprising,
a fuel reforming system according to claim 1; and
a solid oxide fuel cell configured to receive reformed fuel from the fuel reformer system.

13. The fuel reforming system of claim 12, further comprising a nozzle configured for the fuel from the pressure intensifier to pass through on its way to the fuel reformer.

14. The fuel reforming system of claim 13, further comprising a heat exchanger configured to heat the fuel after it passes through the nozzle.

15. The fuel reforming system of claim 14, wherein the system is configured to supply exhaust from the solid oxide fuel cell to the heat exchanger for heating the fuel.

16. The fuel reforming system of claim 1, wherein the fuel reformer is positioned in an exhaust pipe.

17. The fuel reforming system of claim 16, wherein the fuel from the pressure intensifier releases into the exhaust pipe through a nozzle.

18. The fuel reforming system of claim 3, further comprising a heating element configured to heat the fuel prior to its passing through the nozzle.

19. A vehicle comprising the fuel reforming system of claim 1.

20. A method of reforming fuel, comprising:
pumping the fuel from a fuel tank to a first pressure;
passing the fuel through a pressure intensifier to intensify the pressure of at least a portion of the fuel, thereby producing a high-pressure fuel;
passing the high pressure fuel through a nozzle to atomize the fuel; and
supplying the fuel to a fuel reformer.

21. The method of claim 20, further comprising passing the atomized fuel through a heat exchanger prior to the fuel's entering the fuel reformer.

22. The method of claim 20, further comprising drawing air in through the nozzle to mix with the fuel.

23. A method of operating a fuel cell, comprising,
reforming fuel according to the method of claim 20; and
supplying the fuel cell with the reformed fuel.

24. The method of claim 20, further comprising mixing the portion of the fuel with water and pressurizing the water together with the fuel using the pressure intensifier.

25. The method of claim 20, further comprising heating the fuel prior to passing the fuel through the nozzle.

26. The method of claim 20, wherein the nozzle releases the fuel into an exhaust pipe of a vehicle exhaust system.
